(19) United States
(12) Patent Application Publication
(10) Pub. No.: US 2002/0169978 A1
(43) Pub. Date: Nov. 14, 2002

(54) Computer and driving method therefor

(76) Inventors: Chong-In Kim, Suwon city (KR); Sang-Moo Kim, Anyang city (KR)

Correspondence Address: ROBERT E. BUSHNELL, 1522 K STREET NW, SUITE 300, WASHINGTON, DC, 200051202

(21) Appl. No.: 09/987,089

(22) Filed: Nov. 13, 2001

(30) Foreign Application Priority Data
May 14, 2001 (KR) 26216/2001

(51) Int. Cl. H04L 9/32

(52) U.S. Cl. 713/200

(57) ABSTRACT

A computer having a main board provided with a BIOS-ROM for booting the computer and a CPU. A removable storage unit having a casing, a readable and writable memory accommodated in the casing and having a data storing part and a code storing part, and a plug provided at the casing for transmitting data to/from the memory to the computer. The computer also having an interface part provided at the main board and to which the plug of the removable storage unit is removably connected; and a controller controlling the booting of the computer when a user code output from the code storing part and received through the interface part is equal to a unit code stored in the BIOS-ROM. With this configuration, the present invention provides both security and additional storage to the computer.

### CLAIM OF PRIORITY

This application makes reference to, incorporates the same herein, and claims all benefits s accruing under 35 U.S.C §119 from an application entitled Computer earlier filed in the Korean Industrial Property Office on May 14, 2001, and there duly assigned Serial No. 2001-26216 by that Office.

### BACKGROUND OF THE INVENTION

1. Field of the Invention

The present invention relates in general to a computer and a driving method therefor.

2. Description of the Related Art

Generally, a computer system such as a personal computer, a palmtop computer, a notebook computer, etc. needs various security systems which keep an unidentified user from accessing to data stored therein.

As these various security systems, there are a method using a booting password by which a computer system is operated, a bio-recognition method in which a computer can recognize an identification of a user with a fingerprint, a speech, etc. of the user, and so on.

In the case of the security system using the booting password, the booting password is programmed in software into a BIOS (basic input output system)-ROM (read only memory), so that a system is booted depending upon an input of the booting password through a keyboard. Thus, a s security can be inexpensively achieved, but the password thereof is likely to be stolen and used by an unauthorized person.

In the case of the security system using the bio-recognition method, there is little concern about stealing in contrast to the booting password method, but hardware devices are required to realize this system, thereby increasing the cost of production. Moreover, this system has only a security function without providing additional functions for use by the computer, such as a storage function, etc. A security system using a security card, etc. has similar problems.

Accordingly, it will be desired to develop a computer which has a security function free of concern about stealing along with a storage function.

### SUMMARY OF THE INVENTION

Accordingly, the present invention has been made keeping in mind the above-described shortcoming and user's need, and an object of the present invention is to provide a computer which has a security function along with a storage function.

This and other objects of the present invention may be accomplished by the provision of a computer comprising a main board provided with a BIOS-ROM, used in booting a system, and a CPU (central processing unit), further comprising a removable storage unit having a casing, a readable and writable memory accommodated in the casing and having a data storing part and a code storing part, a plug provided at the casing for transmitting data therethrough; an interface part provided at the main board and to which the plug of the removable storage unit is removably connected; and a controller controlling the system to be operated when a user code received from the code storing part through the interface part is equal to a unit code stored in the system, such as in the BIOS-ROM or the CPU.

Preferably, the controller is provided in the BIOS-ROM so as to easily check the removable storage unit and identify the user code.

The removable storage unit further comprises an MP3 (MPEG-1 audio layer 3) playback part reproducing an MP3 file, so that the removable storage unit is used as an MP3 player when it is separated from the interface part.

The interface part is comprised of one of a USB port, an IEEE1394 port, and the others suitable for a desired protocol, for transmitting and receiving data to the main board.

Effectively, the memory is comprised of a flash memory including a smart media card and a compact flash card.

According to another aspect of the present invention, the above and other objects may be also achieved by the provision of a method of driving a computer having a BIOS-ROM booting a system, and a unit code of the system, which comprises the steps of turning on the system; starting a POST by means of the BIOS-ROM; initializing a removable storage unit storing therein a user code, and transmitting data via an interface part; and booting the system when the user code is equal to the unit code after comparing the user code stored in the removable storage unit with the unit code stored in the system.

The initializing step comprises determining whether the removable storage unit is connected to the interface part, and outputting an error message when the removable storage unit is not connected to the interface part, and further comprises outputting an error message when the user code is not equal to the unit code.

Desirably, the unit code is stored in the BIOS-ROM, and the removable storage unit further comprises an MP3 playback part reproducing an MP3 file, or a digital camera.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a perspective view of a computer according to the present invention;

FIG. 2 is an enlarged perspective view of are movable storage unit according to the present invention

FIG. 3 is a block diagram of the computer according to the present invention; and

FIG. 4 is a flowchart showing a booting procedure of the computer according to the present invention.

### DETAILED DESCRIPTION OF THE PREFERRED EMBODIMENT

A preferred embodiment of the present invention will be described in more detail with reference to the accompanying drawings.

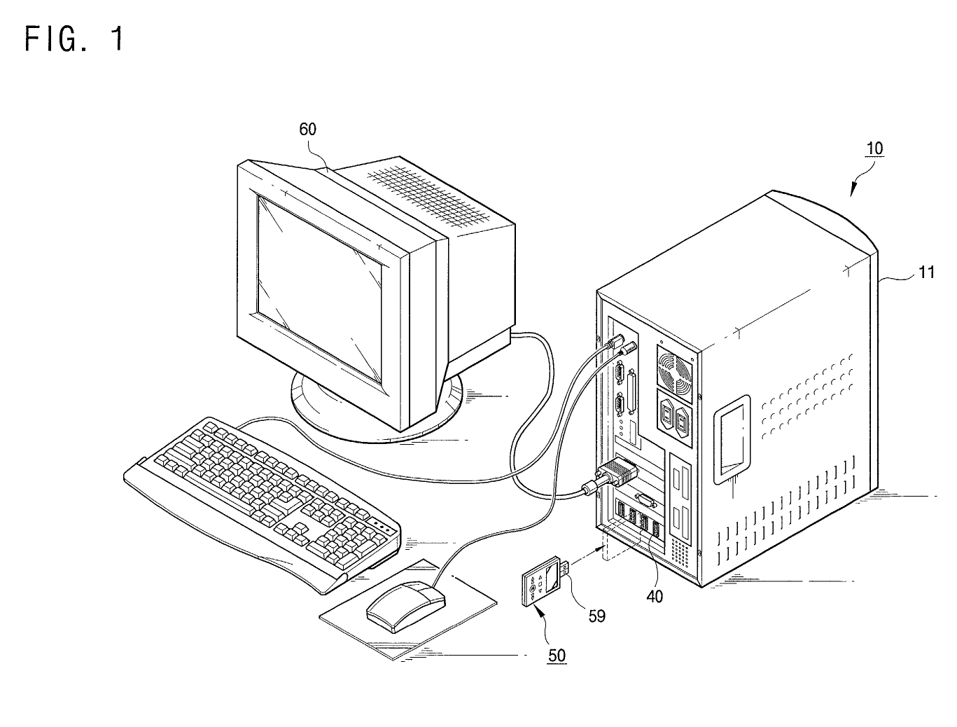

Referring to FIGS. 1, 2 and 3, a computer system according to the present invention is comprised of a personal computer 10 equipped with various kinds of hardware components such as a main board 20, and a monitor 60 outputting a picture signal from the personal computer 10.

The personal computer 10 is comprised of a removable storage unit 50 having a casing 51 and a flash memory 52 storing a user code and common data, an interface part 40 connected with the removable storage unit 50 and transmitting data from the removable storage unit 50 to the main board 20, and a controller 31 controlling booting of the system.

Further, the personal computer 10 includes a housing 11 forming an outer appearance, and various kinds of hardware components including the main board 20 accommodated in the housing and a hard disk drive 33 in which an operating system is stored.

On the main board 20 are mounted a BIOS-ROM 30 driving the system, a central processor unit 21 performing an operation of the system, a RAM (random access memory)(not shown), etc. The BIOS-ROM 30 is a nonvolatile memory provided on the main board 20, and stores therein a BIOS program for booting the system and information on peripheral units. Thus, if the system is turned on, the BIOS-ROM 30 executes the BIOS program and allows the system to pass through a POST (power on self test), thereby booting the system by means of the operating system stored in the hard disk drive 33.

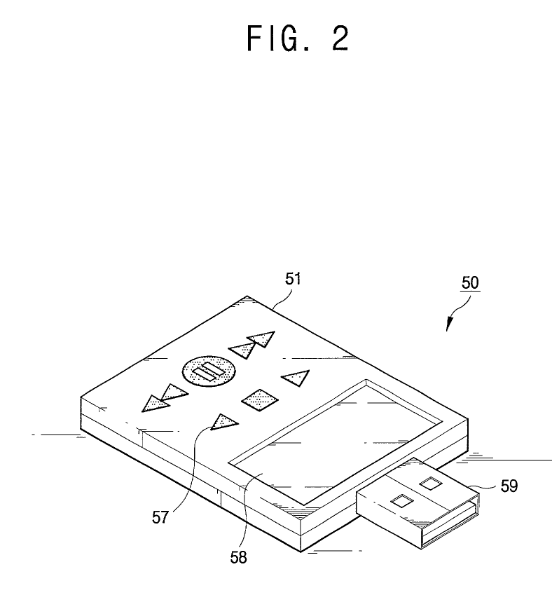

As shown in FIGS. 1 and 2, the interface part 40 is comprised of a USB (universal serial bus) port extended from the main board 20 on the rear side of the housing 11, and is connected to a plug 59 of the removable storage unit 50, which allows data to be transmitted between the main board 20 and the removable storage unit 50. Here, the USB port is used as the interface part 40 for a desktop computer, by way of example. However, in the case of a notebook computer, an IEEE (Institute of Electrical and Electronics Engineers) 1394 port which can be equipped with a PCMCIA (Personal Computer Memory Card International Association) card may be used as the interface part 40.

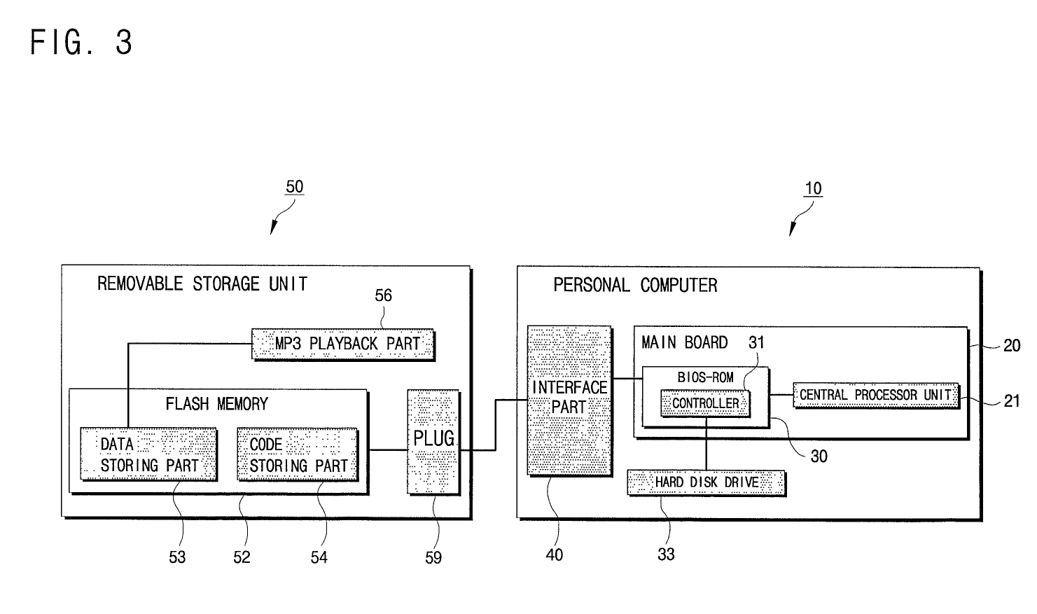

The removable storage unit 50 is, as shown in FIGS. 2 and 3, comprised of the casing 51 having an accommodating space, the flash memory 52 having a data storing part 53 and a code storing part 54, the plug 59 by which the removable storage unit 50 is connected with the interface part 40 so as to transmit data from the flash memory 52 to the main board 20, and an MP3 playback part 56 reproducing an MP3 file.

The casing 51 is, as shown in FIGS. 2 and 3, comprised of a plurality ofplay/control buttons thereon for controlling the MP3 playback part 56, a liquid crystal display (LCD) screen 58 on which a list of the MP3 file is displayed, and a sound output port (not shown).

The flash memory 52 including the data storing part 53 in which common data is stored and the code storing part 54 in which a user code is stored is comprised of a nonvolatile memory to which electric power is continuously supplied; and data stored therein may be deleted and reprogrammed, in the block units, for example. Further, the flash memory 52 includes a smart media card and a compact flash card. In this embodiment, a flash memory of 128 MB may be used. The data storing part 53 occupies all memory areas except the area occupied by the code storing part 54. The code storing part 54, in which a user code is stored, is called when electric power is supplied to the system, and is used as a security key allowing the system to be operated. The data storing part 53 is used as a storing medium storing various files such as an MP3 file after booting the system.

The MP3 playback part 56 reproduces the MP3 file stored in the data storing part 53 into an analog type. The MP3 playback part 56 is controlled by the plurality of play/control buttons 57 provided to the casing 51, and outputs information of the MP3 file on the LCD screen 58. Further, the MP3 file playback part 56 may be driven by a separate power source (e.g. a disposable battery). Thus, when the removable storage unit 50 is separated from the personal computer 10, it may be used as an MP3 player.

As shown in FIG. 3, the controller 31 is provided in the BIOS-ROM 30 and controls the booting of the system. The controller 31 is operated during the POST and determines whether the removable storage unit 50 is connected to the interface part 40. Where the removable storage unit 50 is not connected to the interface part 40, the controller 31 outputs an error message. Oppositely, where the removable storage unit 50 is connected to the interface part 40, the controller 31 compares the user code received from the interface part 40 with a unit code stored in the BIOS-ROM 30, and allows the system to be operated in the case that both codes are equal to each other.

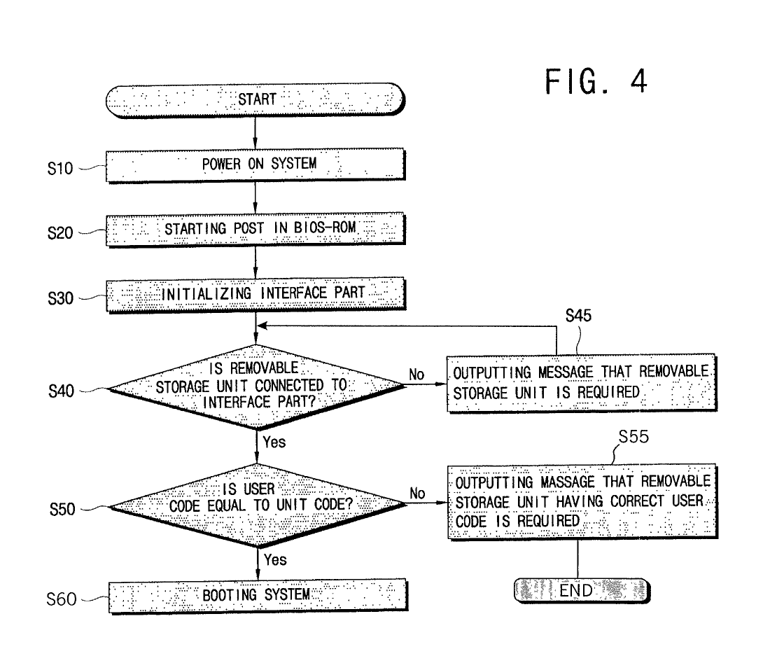

With this configuration, a booting procedure of the computer having the security system according to the present invention will be described hereinbelow with reference to FIG. 4.

First, when a user turns on the system (S10), the BIOS-ROM 30 starts the POST (power on selftest) by which the peripheral units installed in the system are checked (S20). During the POST, a CD-ROM (compact disk read only memory) drive (not shown), a monitor 60, a hard disk drive 33, etc. are checked, and the checked peripheral units are initialized. Further, the BIOS-ROM 30 initializes the USB port as the interface part 40 (S30).

When the USB port 40 is initialized, the controller 31 determines whether the removable storage unit 50 is connected with the USB port 40 (S40). Herein, where the removable storage unit 50 is not connected with the USB port 40, the controller 31 outputs the error message on the screen, SO that the user connects the removable storage unit 50 to the USB port 40 (S45). In the removable storage unit 50 is stored the user code.

Oppositely, where the removable storage unit 50 is connected with in the USB port 40, the controller 31 compares the user code stored in the code storing part 54 of the removable storage unit with the unit code stored in the BIOS-ROM 30 (S50). Herein, if the user code is equal to the unit code stored in the BIOS-ROM 30, the controller 31 executes the rest of the POST and boots the system by means of the operating system stored in the hard disk drive 33 (S60).

However, if the user code stored in the code storing part 54 of the removable storage unit is not equal to the unit code stored in the BIOS-ROM 30, the controller 31 outputs the error message on the screen, so that the user connects the correct removable storage unit 50 to the USB port 40 (S55).

After the booting of the system is finished passing through this procedure, the removable storage unit 50 may be used as a storing medium because it is comprised of a flash memory capable of storing data therein.

Further, when the removable storage unit 50 is separated from the computer, as described above, the removable storage unit 50 may be used as the MP3 player because it includes the MP3 playback part 56. With this configuration, the present invention provides a multi-functional computer having the removable storage unit 50 which serves as a storage medium, an MP3 player, and a security system.

In the above-description, the removable storage unit 50 includes the MP3 playback part reproducing the MP3 file by way of example. However, in addition to, or instead of, the MP3 playback part 56, the removable storage unit 50 may include a digital camera driving part (not shown). Alternatively, the removable storage unit 50 may include neither the MP3 playback part 56 nor digital camera driving part (not shown), as necessary.

In the above-description, the interface part 40 is comprised of the USB port extended from the main board 20. However, as described above, in the case of a notebook computer, the IEEE 1394 port which can be equipped with the PCMCIA card, etc. may be used as above. In this case, the plug of the removable storage unit 50 should have a shape according to the type of port used.

In the above-description, the user code is stored in the flash memory 52 of the removable storage unit 50. However, the user code may be stored in a microcomputer (not shown) provided at the removable storage unit 50 in addition to the flash memory 52.

As described above, by means of a removable storage unit having a data storing part storing common data and a code storing part storing a user code, and a controller comparing the user code with the unit code stored in the BIOS-ROM, a computer including both security and storing functions is provided, according to the present invention.

Although the preferred embodiments of the present invention have been disclosed for illustrative purpose, those skilled in the art will appreciate that various modifications, additions and substitutions are possible, without departing from the scope and spirit of the invention as disclosed in the accompanying claims. For example, once the booting operation confirms that the removable storage unit has the correct user code, the booting process could also ask for a password or biofeedback as further security measures.

What is claimed is:

1. A computer comprising a main board provided with a BIOS-ROM booting a system and a CPU, further comprising:
a removable storage unit having a casing, a readable and writable memory accommodated in the casing and having a data storing part and a code storing part, a plug provided at the casing and transmitting data in the memory therethrough;
an interface part provided at the main board and to which the plug of the removable storage unit is removably connected; and
a controller controlling the system to be operated where a user code received from the code storing part through the plug and interface part is equal to a unit code stored in the BIOS-ROM.

2. The computer according to claim 1, wherein the controller is provided in the BIOS-ROM.

3. The computer according to claim 1, wherein the removable storage unit further comprises an MP3 playback part for reproducing an MP3 file stored in said data storing part.

4. The computer according to claim 1, wherein the removable storage unit further comprises a digital camera, and the digital camera includes an image playback part reproducing an image file.

5. The computer according to claim 1, wherein the interface part is comprised of one of a USB port and an IEEE 1394 port for transmitting data to, or receiving data from, the main board.

6. The computer according to claim 1, wherein the memory is comprised of a flash memory.

7. A method of driving a computer having a BIOS-ROM booting the computer, said method comprising steps of:
turning on the computer;
starting a POST (power on self test) by means of the BIOS-ROM when the computer is turned on;
initializing a removable storage unit having a user code stored therein, said removable storage unit being connected to said computer via a port connected to an interface part for transmitting data between the computer and the removable storage unit;
comparing, upon initialization of the removable storage unit, the user code to a unit code stored in the computer; and
booting the computer when the user code is equal to the unit code.

8. The method according to claim 7, wherein the initializing step comprises,
determining whether the removable storage unit is connected to the interface part, and
outputting an error message where the removable storage unit is not connected to the interface part.

9. The method according to claim 7, further comprising a step of outputting an error message when the user code is not equal to the unit code without booting the computer.

10. The method according to claim 7, wherein the unit code is stored in the BIOS-ROM.

11. The method according to claim 7, wherein the removable storage unit further comprises an MP3 playback part for reproducing an MP3 file.

12. The method according to claim 7, wherein the removable storage unit is comprised of a digital camera, and the digital camera includes an image playback part for reproducing an image file.

13. A computer security system comprising:
a removable storage unit having a casing, a readable and writable memory disposed within the casing and having a data storing part and a code storing part, and a plug provided at the casing, said plug being removably connected to an interface part of a computer for enabling a mainboard of said computer to bidirectionally communicate with said removable storage unit;
a BIOS-ROM disposed on said main board, said BIOS-ROM having a boot program and a unit code stored therein; and
a controller for comparing a user code received from the code storing part through the plug and interface part to the unit code stored in the BIOS-ROM, said controller enabling said BIOS-ROM to boot said computer when said user code and said unit code match.

14. The computer according to claim 13, wherein the controller is provided in the BIOS-ROM.

15. The computer according to claim 13, wherein the removable storage unit further comprises an MP3 playback part for reproducing an MP3 file stored in said data storing part, said MP3 playback part being capable of reproducing said MP3 file even when the removable storage unit is not connected to the computer.

16. The computer according to claim 13, wherein the removable storage unit further comprises a digital camera, and the digital camera includes an image playback part reproducing an image file.

17. The computer according to claim 15, wherein the removable storage unit further comprises a digital camera, and the digital camera includes an image playback part reproducing an image file.

18. The computer according to claim 13, wherein the interface part is comprised of a USB port for transmitting data to, or receiving data from, the main board.

19. The computer according to claim 13, wherein the interface part is comprised of an IEEE 1394 port for transmitting data to, or receiving data from, the main board.

20. The computer according to claim 13, wherein the memory is comprised of a flash memory.
